(19) United States
(12) Patent Application Publication
(10) Pub. No.: US 2020/0243206 A1
(43) Pub. Date: Jul. 30, 2020

(54) Nuclides Bombardment Method and System for Neutron Generation

(71) Applicant: Tzu-Yin Chiu, Milpitas (US)

(72) Inventor: Tzu-Yin Chiu, Milpitas (US)

(73) Assignee: Tzu-Yin Chiu, Milpitas, CA (US)

(21) Appl. No.: 16/775,229

(22) Filed: Jan. 28, 2020

Related U.S. Application Data
(63) Continuation-in-part of application No. 14/849,574, filed on Sep. 9, 2015, now abandoned.

(30) Foreign Application Priority Data
Sep. 11, 2014 (CN) 201410457908.5

(51) Int. Cl. G21B 1/19; G21B 1/15

(52) U.S. Cl. CPC G21B 1/19; G21B 1/15

(57) ABSTRACT

A method for nuclide bombardment for neutron generation includes providing a nuclide bombardment target. The target has a metallic single-crystalline layer including a metallic element, the single-crystalline layer including lattice channels disposed of therein, and isotopes of a first element, configured as interstitial elements in the lattice channels in the single-crystalline layer. The method also includes positioning the metallic single-crystalline layer with respect to a bombardment apparatus, such that the bombardment apparatus is configured for injecting particles into the metallic single-crystalline layer substantially along the lattice channels of the single crystalline lattice. The method further includes injecting isotopes of a second element into the metallic single-crystalline layer substantially along the direction of the lattice channels, thereby increasing neutron generation.

### CROSS-REFERENCES TO RELATED APPLICATIONS

This application is a continuation-in-part to U.S. patent application Ser. No. 14/849,574, filed Sep. 9, 2015, entitled “Method and System for Thermal Nuclear Fusion,” which claims priority to Chinese Patent Application No. 201410457908.5, filed Sep. 11, 2014, entitled “Nuclides Bombardment Target, Bombardment System, and Method,” by inventor Tzu-Yin Chiu, commonly assigned, incorporated by reference herein for all purposes.

### FIELD OF INVENTION

The present invention relates generally to thermal nuclear fusion based on nuclides bombardment. More specifically, embodiments of the invention include methods and systems for enhanced neutron generation based on channeling in nuclide bombardment for fusion reaction. However, it would be recognized that the invention has a much broader range of applicability.

### BACKGROUND OF THE INVENTION

In nuclear physics, a nuclide is an atomic species characterized by the specific constitution of its nucleus, i.e., by its number of protons Z, its number of neutrons N, and its nuclear energy state. A set of nuclides with equal proton number (atomic number), i.e., of the same chemical element but different neutron numbers, are called isotopes of the element. Nuclides can be involved in nuclear fusion, which is a nuclear reaction in which two or more atomic nuclei come close and then collide at a very high speed, before adjoining to form a new type of atomic nucleus. During this process, matter is not conserved because some of the matter of the fusing nuclei is converted to energy (i.e., photon).

Current research on controlled nuclear fusion is focused on two directions: magnetic field confinement and inertial confinement. Such developments include a variety of Tokamak or Super Tokamak devices and laser-induced deuterium ball implosion devices. In addition, experimental studies of the bombardment of a deuterium beam of an erbium deuteride target have been reported. It has also been proposed to use a very low-temperature solid deuterium/tritium (D (i.e., ²H)/T (i.e., ³H)) or a heavy ice hydrogel containing deuterium/tritium as the target.

### BRIEF SUMMARY OF THE DISCLOSURE

Conventional methods for controlling nuclear fusion as described above suffer many limitations. For example, although, in laser-induced implosion, the impact can be detected due to nuclear fusion, it cannot achieve energy balance due to Bremsstrahlung, or deceleration radiation, which is electromagnetic radiation produced by the deceleration of a charged particle when deflected by another charged particle, typically an electron by an atomic nucleus. In other methods, it is often difficult to maintain continuous ultra-low temperature or to achieve efficient energy transfer. Embodiments of the invention provide methods and systems for more efficient and effective nuclide bombardment for the fusion reaction to enhance neutron generation, for applications such as medical application or transmutation of fission waste products.

According to some embodiments of the present invention, methods are provided for enhanced neutron generation for medical application or transmutation of fission waste products, with improved bombardment process and reaction process control.

In some embodiments of the present invention, a method is provided for nuclide bombardment for neutron generation. The method includes providing a nuclide bombardment target. The target includes a metallic single-crystalline layer including a hydrogen-absorbing metallic element, and the single-crystalline layer has lattice channels disposed of therein. The target also includes first hydrogen isotopes, configured as interstitial elements in the lattice channels in the single-crystalline layer. The method also includes positioning the metallic single-crystalline layer with respect to a bombardment apparatus, such that the bombardment apparatus is configured for injecting particles into the metallic single-crystalline layer substantially along the lattice channels of the single crystalline lattice. Next, second hydrogen isotopes are injected into the target substantially along the direction of the lattice channels, to allow deeper penetration, thereby increasing neutron generation.

Some embodiments of the above method also includes positioning the metallic single-crystalline layer to receive the second hydrogen isotopes at a selected incident angle for increased neutron generation. The selected incident angle can be determined by varying the incident angle of the second hydrogen isotopes with respect to the metallic single-crystalline layer. For example, the target of the metallic single-crystalline layer can be rotated with respect to the incident beam during the bombardment, and the backscattered particle counts can be measured and compared. In other embodiments, once an optimal incident angle is determined, it can be used with identical or similar targets.

According to some embodiments of the present invention, a method for nuclide bombardment includes providing a nuclide bombardment target, which includes a metallic single-crystalline layer having a hydrogen-absorbing metallic element. The single-crystalline layer includes lattice channels disposed of therein. The target also includes first hydrogen isotopes, configured as interstitial elements in the lattice channels in the single-crystalline layer. The method further includes injecting second hydrogen isotopes into the target substantially along the direction of the lattice channels.

In an embodiment of the above method, the single-crystalline layer is characterized by a thickness of 5 um or less. In another embodiment, the method also includes subjecting the target too low temperature to restrain the thermal vibrations of the single-crystalline lattice and/or to cause recrystallization. In another embodiment, the target surface is substantially perpendicular to the lattice channels in the single-crystalline layer. In another embodiment, the metallic element is selected from Pt, Pd, Ti, or Ni.

According to some embodiments of the invention, a nuclear species bombardment system includes a target and a bombardment apparatus. The target has a target body of a single crystalline layer and isotopes of a first element disposed as interstitial nuclides along lattice channels in the single crystalline layer. The bombardment apparatus is configured for injecting isotopes of a second element into the target substantially along said crystal lattice channels.

In an embodiment of the above system, the first element comprises one or more of hydrogen, helium, boron, and aluminum. In an embodiment, the second element comprises one or more of hydrogen, helium, boron, and aluminum. In another embodiment, the isotopes of the first element include deuterium (D) or tritium (T), and the isotopes of the second element include deuterium (D) or tritium (T). In an embodiment, the isotopes of the second element have energies of 10 keV or greater. In another embodiment, the system also includes a cooling apparatus configured for lowering the temperature of the target for restricting vibration of the metal element single crystalline lattice. In another embodiment, the system also includes an energy collection apparatus for collecting energy from energetic particles and energy produced by the bombardment of the first hydrogen isotopes on the second hydrogen isotopes.

According to some embodiments of the invention, a method of forming a target for nuclide bombardment includes providing a metallic single crystal layer having hydrogen-absorbing properties, and exposing the metallic single crystal layer to a fluid containing isotopes of hydrogen, such that the isotopes of hydrogen are absorbed into the single crystal layer as interstitial nuclides. The hydrogen isotopes are disposed substantially along lattice channels of the metallic single crystal thin film.

In an embodiment of the above method, the single-crystalline layer is characterized by a thickness of 5 um or less. In another embodiment, a surface of the target is substantially perpendicular to the lattice channels in the single-crystalline layer. In an embodiment, the metallic single crystal layer comprises one or more elements selected from one or more of Pt, Pd, Ti, or Ni.

According to some embodiments of the invention, a nuclide bombardment target includes a single-crystalline layer having a metallic element with hydrogen-absorbing properties and hydrogen isotopes configured as interstitial nuclides in the single-crystalline layer. The hydrogen isotopes form a lattice that includes nuclides disposed substantially along lattice channels in the single-crystalline layer.

In an embodiment of the above target, the single-crystalline layer is characterized by a thickness of 5 um or less. In an embodiment, a surface of the target is substantially perpendicular to the lattice channels in the single-crystalline layer of the metal element of the channel or angled. In another embodiment, the metallic element is selected from Pt, Pd, Ti, or Ni.

According to some embodiments of the invention, a method for nuclide bombardment for neutron generation includes providing a nuclide bombardment target. The target has a metallic single-crystalline layer including a metallic element, the single-crystalline layer including lattice channels disposed of therein, and isotopes of a first element, configured as interstitial elements in the lattice channels in the single-crystalline layer. The method also includes positioning the metallic single-crystalline layer with respect to a bombardment apparatus, such that the bombardment apparatus is configured for injecting particles into the metallic single-crystalline layer substantially along the lattice channels of the single crystalline lattice. The method further includes injecting isotopes of a second element into the metallic single-crystalline layer substantially along the direction of the lattice channels, thereby increasing neutron generation.

Depending on the embodiments, one or more of the following advantages can be achieved. For example, some embodiments provide a new and efficient target for bombardment and methods for forming the target. Some embodiments provide a method and system for nuclide bombardment that greatly enhance collision probability between incident nuclides and nuclide target of interstitial. In some embodiments, methods are provided for reducing (and even temperature freezing) lattice vibrations in the target. In some embodiments, methods are provided for controlling the target temperature and recrystallization for maintaining the monocrystalline structure and lattice integrity. In some embodiments, methods are provided for enhanced neutron generation for medical application or transmutation of fission waste products, with improved bombardment process and reaction process control. In some embodiments, methods are provided for energy harvesting with improved bombardment process and reaction process control. The efficient energy-producing and harvest method also helps to conserve resources.

A further understanding of the nature and advantages of the present invention may be realized by reference to the remaining portions of the specification and the drawings.

### BRIEF DESCRIPTION OF THE DRAWINGS

FIG. 1 is a diagram illustrating the lattice structure of the hydrogen-absorbing metal palladium;

FIG. 2 is a diagram illustrating a perspective view of a palladium-hydrogen, Pd—H (or Pd-D/T), system in a typical phase;

FIG. 3A shows a perspective view of two adjacent Pd cells in a palladium (Pd) target according to an embodiment of the present invention;

FIG. 3B is a front view of the unit cell in FIG. 3A;

FIG. 3C illustrates a partial enlarged view of FIG. 3B;

FIG. 3D illustrates a top view of the cell of FIG. 3A, viewed in the [001] direction of crystal lattice (in the direction of lattice vectors (0,0,−1));

FIG. 3E illustrates a cross-sectional view of FIG. 3D in the [110] plane;

FIG. 3F illustrates an enlarged view of part of FIG. 3C;

FIG. 4 is a schematic diagram of a nuclide bombardment target according to an embodiment of the present invention;

FIG. 5 is a schematic diagram illustrating nuclear fusion caused by D and T collision;

FIG. 6 is a schematic diagram of a nuclide bombardment system according to an embodiment of the present invention, and

FIG. 7 is a simplified flowchart of a method for nuclide bombardment.

FIG. 8 is a simplified diagram of an RBS (Rutherford Backscattering Spectrometry)system according to embodiments of the present invention;

FIG. 9 shows a summary of results from SIMS measurements in both linear coordinates and logarithm coordinates according to embodiments of the present invention;

FIG. 10 shows results from XRD (X-ray diffraction) measurements according to embodiments of the present invention;

FIG. 11 shows results from random and channeling RBS measurements according to embodiments of the present invention;

FIG. 12 shows results from TEM (Transmission Electron Microscope) measurements according to embodiments of the present invention;

FIG. 13 shows the output energy spectrum during ion beam bombarding the target according to embodiments of the present invention; and

FIG. 14 illustrates the experimental results of particle counts in channeling-enhanced fusion reaction according to embodiments of the present invention.

It should be understood that the drawings are exemplary only, and for ease of description, the size of the various parts shown in the drawings are not drawn according to an actual proportional relationship. Further, in the drawings, palladium (Pd) is used as an example of a target metal, but as explained below, the target is not limited to metal palladium (Pd).

### DETAILED DESCRIPTION OF THE INVENTION

The following descriptions of the embodiments are illustrative only, and not as any limitations on the disclosure and the application or use. In the following description, techniques, methods, and components known to one of ordinary skill in the relevant art will not be discussed in detail. But in appropriate cases, the techniques, methods, and equipment should be considered as part of the specification. All the examples shown here and discussed any specific value should be construed as merely illustrative, and not as a limitation. Thus, other exemplary embodiments may have different values. It should be noted, unless otherwise specified, the relative arrangement of components and steps, and the numerical expressions and values do not limit the scope of the disclosure. It is also noted that, in the drawings the same reference numerals denote the same object, and therefore, when an object is illustrated in a drawing, in the subsequent description thereof will not be further discussed.

Note that, in the following description, in the absence of the contrary, the term “hydrogen” refers to the various isotopes of elements in the periodic table of the first number, i.e., including H, D, and T, or the like; the term “isotopes of hydrogen” or “hydrogen first/second isotope” refers to isotopes, e.g., D, T, and so on, of ¹H, the first element in the periodic table of elements. Similarly, citation of some other elements refers to various isotopes of the element; and citation of certain isotopes of other elements refers to the isotopes of the element that are capable of fusion reaction. As used herein, the term “nuclide” means a particle or particle group containing nuclei, including but not limited to, e.g., atoms, ions, ion clusters, and so on.

Embodiments of the present invention provide a target for nuclide (also referred to as bombard nuclides) bombardment. The target includes a monocrystalline thin metal target body. In some implementations, the metal may be a metal having hydrogen-absorbing properties. Metals having hydrogen absorbing properties, include, but are not limited to, platinum (Pt), palladium (Pd), titanium (Ti), nickel (Ni) and the like, in which hydrogen (including its isotopes) can be dissolved. The target includes isotopes of hydrogen (which may also be referred to as first isotopes), e.g., deuterium and/or tritium. The first hydrogen isotopes are disposed in the single crystal of the metal as interstitial nuclides. The target may be a single crystal thin layer of one or more of the metals having a hydrogen-absorbing property. The single-crystal thin layer can absorb a relatively large amount of hydrogen isotopes. In certain embodiments, the target may even be hydrogen-saturated.

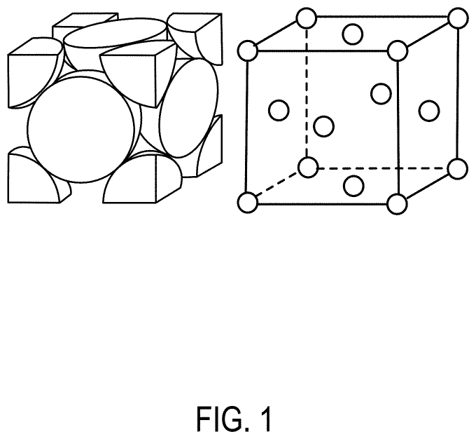

FIG. 1 shows a schematic diagram as an example of the hydrogen-absorbing metal palladium lattice structure. As shown, the palladium (Pd) crystal has a face-centered cubic (fcc) structure, each cell having four Pd atoms, four octahedral interstitial positions (O), and eight tetrahedral interstitial positions (T). In embodiments of the invention, hydrogen nuclides dissolved in the crystal lattice occupy the octahedral interstitial positions (O).

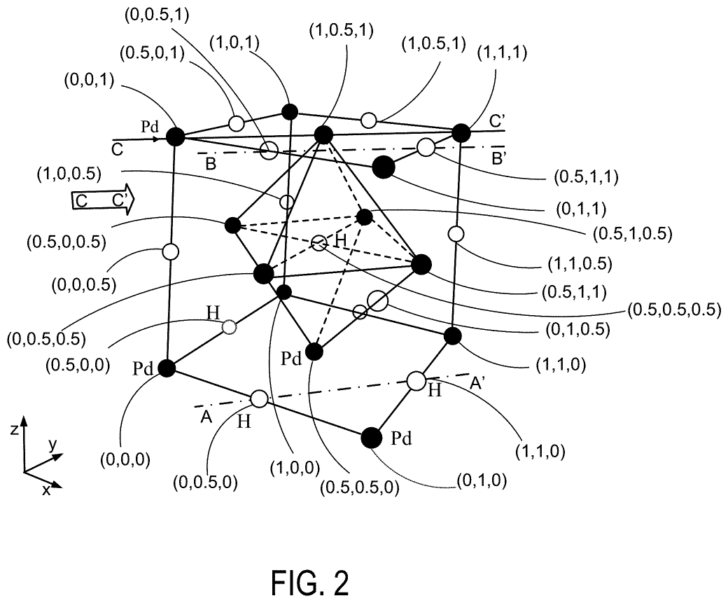

FIG. 2 is a perspective view showing positions of hydrogen nuclides (in this case, atoms) in a typical phase of the palladium-hydrogen system. It can be seen that the hydrogen nuclides fill all octahedral interstitial positions (O). FIG. 2 also shows the crystal lattice of coordinates (x, y, z) of various Pd and H atoms (in units of the lattice constant of Pd). As can be seen from FIG. 2, when hydrogen nuclides fill all octahedral interstitial positions, hydrogen nuclides form an fcc sub-lattice. However, FIG. 2 shows the distribution of the hydrogen nuclides when hydrogen is dissolved in the palladium lattice under ideal conditions. In the actual process of dissolution, there is also the diffusion of hydrogen in the palladium. Therefore, not all of the O interstitial positions in the Pd lattice may be occupied by the hydrogen nuclides.

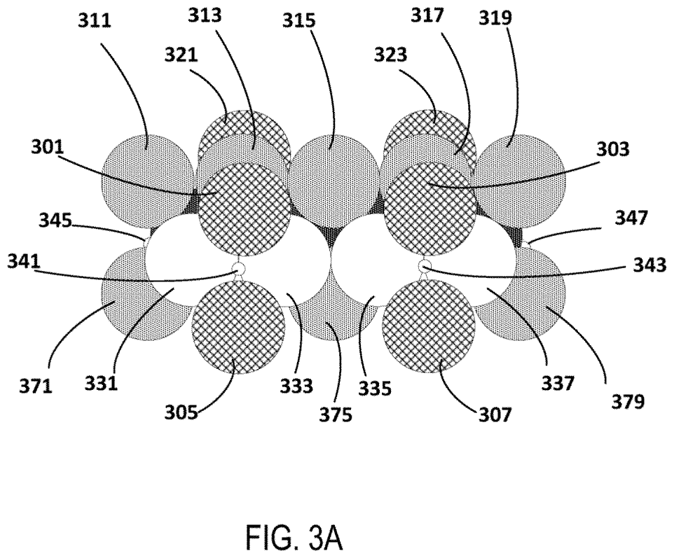

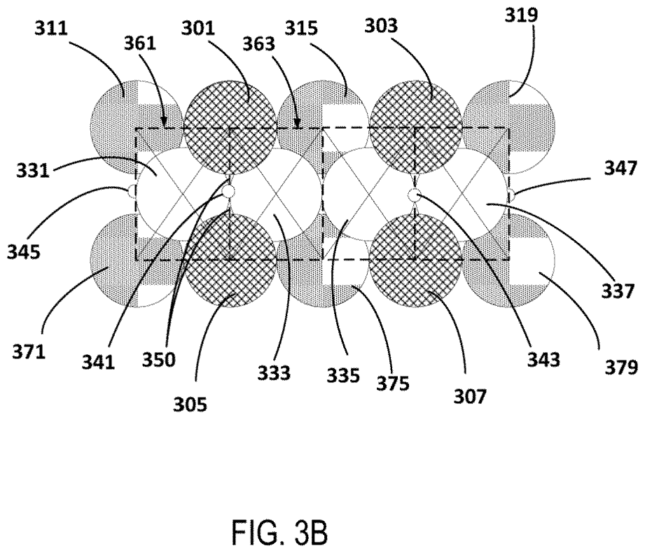

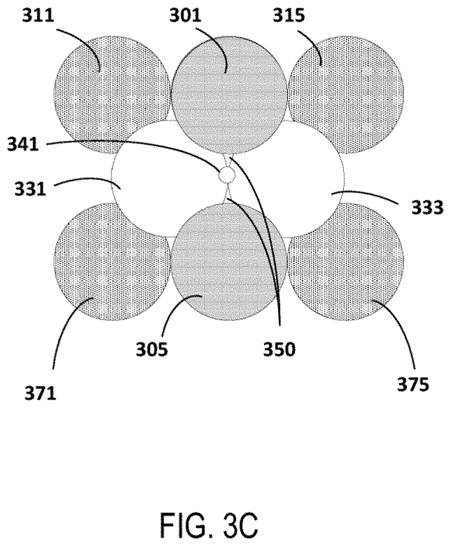

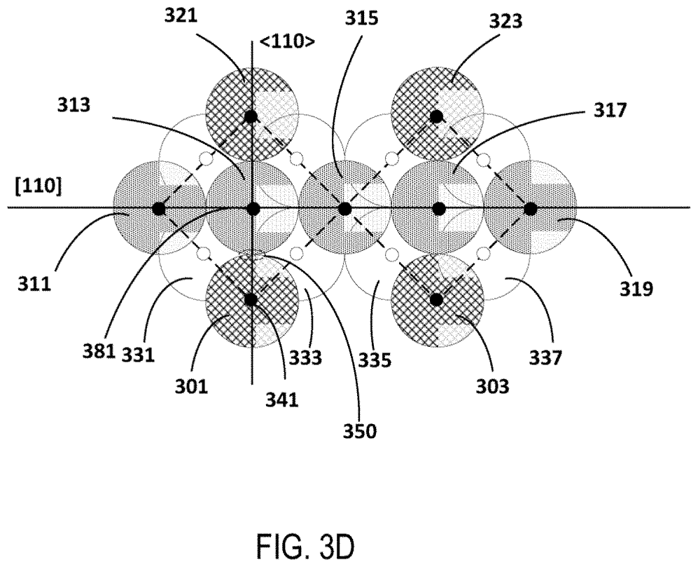

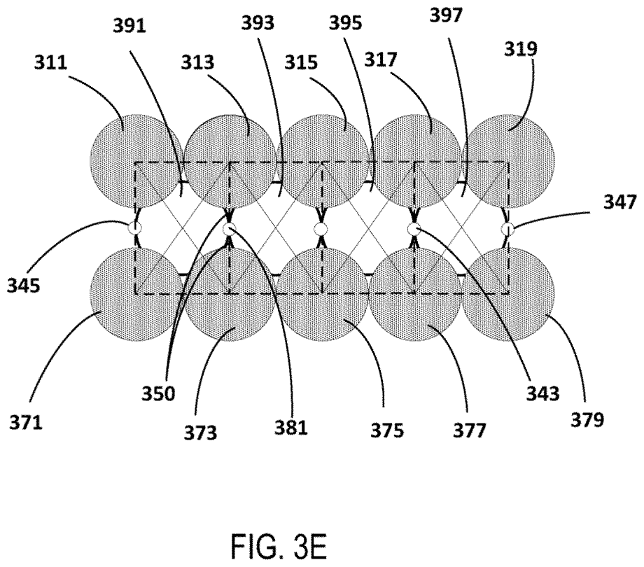

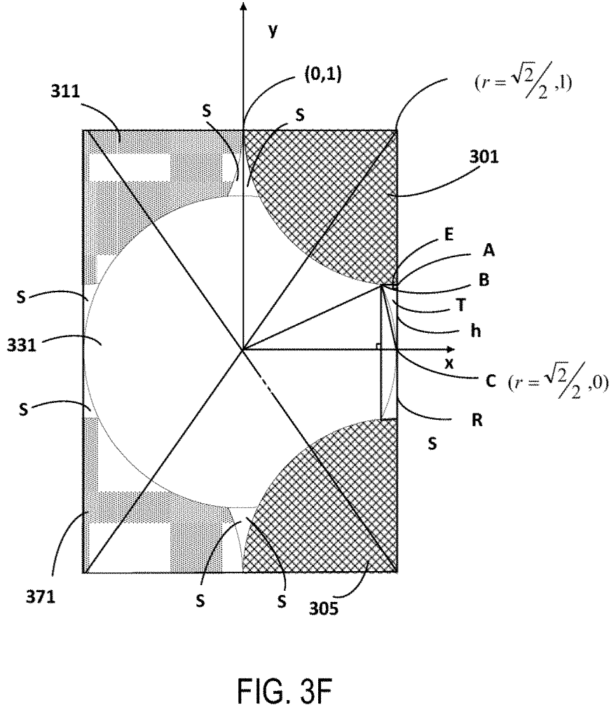

Nevertheless, hydrogen nuclides (e.g., D or T, i.e., the first isotopes) may form a matrix of nuclides substantially along the <110> crystal orientation of a single crystal lattice of palladium, as shown in dashed lines A-A′ and B-B′ in FIG. 2. In conjunction with FIGS. 3A-3E, it will be shown that the hydrogen nuclides (e.g., D or T) can form a matrix of nuclides arranged along channels of a single crystal of palladium target. Here, it is noted that FIG. 2 is a perspective view. Therefore, dot-dash lines A-A′ and B-B′ may not be shown to be strictly parallel to each other.

Because of the lattice channels, incident nuclides (e.g., ions of D/T) that are injected along the channels can reach more deeply into the target, reducing Bremsstrahlung or deceleration radiation and increasing the collision probability of incident nuclides and interstitial nuclides. In addition, due to the lattice atoms and electron clouds in the metal single crystal lattice, the incident beam of nuclides may be “squeezed” or “funneled” into the lattice channels. As described above, the hydrogen nuclides in the target are disposed in the interstitial positions in the channels of the metal target, thereby further increasing the density of the incident nuclides, increasing nuclides' collision probability, and thus increasing the possibility of nuclear fusion. Further, lattice atoms at the edges of the channels make it harder for the incident nuclides to leave the channel, which in turn increases the collision probability of an incident and interstitial nuclides.

FIG. 3A shows a perspective view of two adjacent palladium (Pd) unit cells in a Pd target according to an embodiment of the present invention. In FIG. 3A, each of the large circles represents a Pd atom, and each small circle represents a hydrogen (i.e., D/T). Here, D will be used as an example to explain FIG. 3A. Pd atom 301 and 305 in FIG. 3A are two apex atoms that are closest to an observer when viewing the cell in FIG. 2 from the direction of an arrow C-C′, corresponding to the Pd atoms with coordinates (0, 0, 1) and (0, 0, 0) in FIG. 2. Similarly, Pd atom 303 and 307 in FIG. 3A correspond to the Pd atoms with coordinates (0, 1, 1) and (0, 1, 0) in FIG. 2. As shown in FIG. 2, the arrow C-C′ line extends along the diagonal of the upper surface of the unit cell in the C-C′ line direction, i.e., <110> crystal orientation. Atoms 301, 311, 321, and 315 constitute the four corners of atoms of the [0,0,1] plane (i.e., the upper surface in FIG. 2), and atom 313 is located in the face center of that plane. Pd atom 303, 315, 319, 323 and Pd atom 317 are located at the four corners and a face-centered position on the [0, 0, 1] surface of another cell.

Atoms 341, 343, 345, and 347 represent D atoms “frozen” in the cell. D atom 341 corresponds to the hydrogen atom with coordinates (0, 0, 0.5) in FIG. 2. Note that FIG. 3A only shows some of the deuterium atoms. For example, D atoms on the [0, 0, 1] crystal face (top surface in FIG. 2) are not shown. Pd atoms 331/335 and 333/337, respectively, are a face-centered atom in the [0,1,0] plane and a face-centered atom in the [1,0,0] plane, corresponding to

Pd atoms at coordinates (0, 0.5, 0.5), respectively. Pd atom 371, 373, 375, 377, and 379 represent atoms along diagonal lines on the lower surface of adjacent cells as shown in FIG. 2. Atoms 373 and 377 are hidden and not shown in FIG. 3A. More details are shown below in FIG. 3E.

FIG. 3B illustrates a front view of the unit cell in FIG. 3A along the arrow in FIG. 2, i.e., in the <110> crystallographic orientation in the single crystal Pd lattice. The dashed line boxes in FIG. 3B show the surfaces of cubic unit cells. For example, dashed box 361 spanned by atoms 301, 305, 311, and 371 represents a surface, which corresponds to the [100] surface of the lattice shown in FIG. 2, i.e., the surface that contains the face-centered atoms with coordinates of (0.5, 0, 0.5). Similarly, dashed box 363 spanned by atoms 301, 305, 315, and 375 represents a surface, which corresponds to the [010] surface of the lattice shown in FIG. 2, i.e., the surface that contains the face-centered atoms with coordinates of (0, 0.5, 0.5).

It can be seen from FIG. 3B, there are two spaces 350 between neighboring Pd atoms 301, 305, 331 and 333. FIG. 3C shows an enlarged view of part of FIG. 3B, which better shows the space 350. It should be understood that the D atom 341 is positioned in front of space 350, i.e., closer to the viewer.

FIG. 3D shows a top view of the unit cell of FIG. 3A. The white small circles represent D nuclides, and the black small circles denote D nuclides shielded from view by the Pd atoms, such as D nuclide 341. In FIG. 3D, D nuclide 381 is surrounded by four face-centered Pd atoms (e.g., 331, etc.) and shielded from view at the top by Pd atom 313. Similarly, at the bottom of D nuclide 381, there is an adjacent Pd atom (not shown). D nuclide 381 corresponds to the hydrogen nuclide with coordinates (0.5, 0.5, 0.5) in FIG. 2, surrounded by six face-centered Pd atoms, which form the center octahedron in FIG. 2. Also shown in FIG. 3D are exemplary lattice orientation planes <110> and [110]. Those skilled in the art will readily appreciate that the crystalline orientations <110>, <101>, and <011> are equivalent, and that crystalline orientations <100>, <001>, and <010> are equivalent, depending on the origin and axis orientation of the coordinate system; the same is true for orientation of crystalline planes.

FIG. 3E illustrates a cross-sectional view of the [110] plane in FIG. 3D. FIG. 3E shows the D impurities on the cross section, such as 345, 347, and so on. Pd atoms 391, 393, 395, 397 represent face-centered Pd atoms behind the cross-section, which correspond to the Pd atoms with coordinates (0.5, 1, 0.5) and (0.5, 1, 1) shown in FIG. 2. FIG. 3E also shows a couple of similar spaces 350.

Those skilled in the art will appreciate that the diagrams in FIGS. 3A-3E are based on a rigid metal lattice atoms model. It is known that atoms include atomic nuclei and electrons, and most of the volume of an atom is occupied by its orbital electrons (electron orbital or electron cloud), and the distribution of electrons is more sparse in the outer electron orbits than the inner orbits. Thus, since there is space 350 and sparse distribution of outer electrons, when incident D/T beam is substantially along the <110> crystallographic orientation of the Pd lattice, the Pd lattice atoms present like “funnels” to squeeze on the incident D/T beam. As a result, the incident beam entering the target can be limited or constrained to more narrow beams to travel in between the interstitial spaces substantially along the <110> crystal orientation in the Pd crystal lattice. Thus the probability of collisions between D-D or D-T is largely increased. Here, such a channel is called a lattice channel. The channels are formed by metal lattice nuclides in the target, which extend substantially along a certain crystal orientation. For example, in FIG. 3B, the channels extend along the <110> crystallographic orientation of the Pd lattice.

FIG. 3F shows an enlarged view of part of FIG. 3C. As shown in FIG. 3F, the rigid balls of Pd atoms 311, 301, 371, and 305 are located substantially at each vertex of the rectangle model. In the following calculation, perpendicular x and y axes are shown in FIG. 3F with the coordinate origin located at the center of the sphere 331. The line connecting the centers of atom spheres 311 and 301 intersects the y-axis at coordinates (0, 1). The line connecting the centers of spheres 301 and 305 and intersects the x-axis at coordinates (\sqrt{2}/2, 0). Based on FIGS. 3C and 3F, the unit length in FIG. 3F is selected such that the long side of the rectangle in FIG. 3F has a length of 2, which is equal to the lattice constant a, and the short side of the rectangle in FIG. 3F has a length of \sqrt{2}, which is equal to \sqrt{2}/2 times lattice constant a.

In FIG. 3F, the space between the spheres includes eight wedge-shaped regions marked by “S.” Based on the rigid sphere model, the area of these spaces is now calculated. As shown on the right-hand side of FIG. 3F, the wedge-shaped region is approximated as a right triangle T with three vertices A, B, and R. Vertex A is at the intersection of sphere 301 and the right edge of the triangle in FIG. 3F, and vertex B is the intersection of sphere 331 and a line drawn from vertex A and parallel to the x-axis. Triangle T has a long edge h and a short edge E. The length of the long edge h can be calculated as follows:

h=1−r=1−\sqrt{2}/2≈0.292893219.

The length of the short edge E can be calculated as follows:

E=r−\sqrt{r²−h²}=r−\sqrt{(\sqrt{2}/2)²−(1−\sqrt{2}/2)²}≈0.063513.

Thus, the area of the spaces in the rectangle in FIG. 3F can be calculated as follows:

Area=8×Area_of_triangle_T=8×[½×(0.292893219)×(0.063513)]≈8×0.009301=0.074408.

The ratio of the area of the rectangle to the area of the spaces can be calculated as follows:

2r*2/(8×Area_of_triangle_T)=2(\sqrt{2}/2)×2/0.074408≈38.

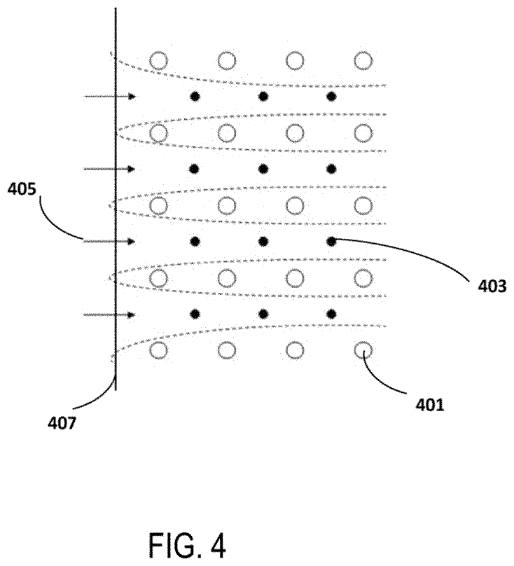

Because of the impact of the aforementioned “squeezing” or “funnel” effect, incident particles D/T entering the rectangular shown in FIG. 3F will be squeezed into the blank area or near the space S, thereby forming a “lattice channel.” As shown in FIG. 3C, the D/T nuclides in the target are disposed substantially along the lattice channel, as shown more clearly in FIG. 4 below. The ratio of the rectangular area to the area of the spaces can be considered an effective magnification factor, which is shown above to be approximately 38. However, considering the atomic electron cloud, the sparse outer orbital electrons, and the presence of nuclides D/T in the target, the above calculation could be carried out using a rectangle approximation. In FIG. 3F, the area of a rectangle R is twice the area of the triangle T. So, in this approximation, the magnification factor M_{A} would be about 19. Therefore, those skilled in the art may appreciate that the actual magnification factor could be much greater than 19 and may be close to 38.

It should be understood that the values calculated above are merely illustrative and not restrictive. Since different models and accuracy of the calculation can be used, the values of the amplification factor may also vary. It is also understood that, although palladium (Pd) has been described as an example, the present invention can be applied to, and not limited to, platinum, nickel, and the like. For example, other metals having a hydrogen-absorbing property (e.g., a transition metal) are also applicable.

In embodiments of the present invention, the thickness of the target is selected such that the resulting high energy fusion products (e. g., high-energy particles) can leave the target without causing a significant loss of energy. In some exemplary embodiments, the thickness of the target can be, for example, 5 μm or less, 3 μm or less, 2 μm or less, 1.5 μm or less, or 1 μm or less. In other embodiments, according to the different applications, different target thicknesses can be used.

Furthermore, in some embodiments of the present invention, the target is cooled to constrain thermal vibrations of the metal single crystal lattice, which can reduce effects of the lattice vibration on incident nuclides, reducing the effective collisional cross section (here, also referred to the incident beam), e.g., scattering. As used herein, the term “reduced temperature” includes ambient temperature (e.g., room temperature, about 300 K) or less, and even up to near 0 K. The cooling can be provided, for example, by submersion in or sublimation of water, liquid nitrogen, liquid helium, or the like.

In some embodiments, as will be described later with reference to FIG. 4, the incident surface of the target is substantially perpendicular to the channels in the single crystal lattice of the metal element, i.e., at an angle of substantially 90 degrees. In the above-mentioned example of Pd, the incident surface of the target (see, 407 of FIG. 4) is substantially perpendicular to the <110> crystallographic orientation in a single crystal lattice of Pd (i.e., the lattice channel direction). In other words, the incident surface of the target Pd single crystal lattice is substantially along the <110> crystal plane. However, in certain other embodiments, the incident surface of the target can be at another angle with a channel in the single crystal lattice of the metal element.

In some embodiments, there is no particular limitation on the content of hydrogen isotopes in the target. The amount of hydrogen isotopes preferably does not cause damage to the integrity of the single crystal lattice of the target. For example, the content of hydrogen isotopes in the target may be less than or equal to about 20 atomic percent. It is known that such content does not cause a phase change Pd single crystal.

In some embodiments of the present method, the above target can be formed by the following method. The method includes providing a single crystal thin layer having hydrogen-absorbing metal elements, e.g., Pd, Pt, Ti, Ni, etc. The thin layer may have a thickness of, for example, about 5 μm or less, 3 μm or less, 2 μm or less, 1.5 μm or less, or 1 μm or less. The thin single crystal layer of these metal elements can be formed using known methods, e.g., a single crystal layer can be formed by annealing palladium (Pd), etc. Therefore a detailed description of the method will be omitted here. The method further includes the single crystalline thin metal layer absorbing a fluid containing first hydrogen isotopes, such that the first isotopes of hydrogen are absorbed in the metal element single crystal layer as the interstitial nuclides.

In the palladium (Pd) example, when a single crystal of palladium (Pd) layer absorbs hydrogen nuclides (e.g., molecular hydrogen), the hydrogen molecules are adsorbed by the palladium surface first, then dissociated into atoms inside the palladium target, forming a solid solution phase. Thus, as described above, the hydrogen isotopes can form a matrix including hydrogen nuclides substantially disposed along the channels in the single crystal of the metal element. A similar process also exists in other hydrogen-absorbing metals. Further, when the palladium (Pd) absorbs the hydrogen, the crystal lattice may exhibit a little swelling, but the FCC structure remains. In this case, an increase in the thickness caused by hydrogen absorption is not to be considered. In some embodiments of the present disclosure, it is also possible to constrain lattice thermal vibration energy of the single crystal of the metal by cooling, thereby reducing or eliminating the effects of lattice vibrations.

FIG. 4 is a schematic diagram of a nuclide target in accordance with an embodiment of the present invention. The target includes a single crystalline palladium (Pd) 401 and first hydrogen isotopes (e.g., D or T) 403 as interstitial nuclides. In some embodiments, the hydrogen isotopes of hydrogen form a lattice or matrix that includes nuclides substantially along the channels of the metal element single crystal lattice. In a method according to some embodiments of the invention, additional hydrogen isotopes 405 (also referred to as second isotopes, i.e., bombarding nuclides), e.g., T and/or D, are projected toward the target substantially along the lattice channels of metal element single crystal. In some embodiments, the incident energy can be greater than or equal to 10 keV (thousand electron volts) of energy.

In some embodiments, the incident energy can be, but is not limited to, e.g., 10˜100 keV, or 10˜200 keV. In embodiments of the invention, if the incident hydrogen isotope nuclides have energy of 10 keV, they can provide sufficient probability of the occurrence of nuclear fusion. However, it should be understood that the application of the present invention is obviously not limited to fusion applications. In addition, it should be understood that the present invention is not limited to a single nuclide bombardment of D or T atoms or ions. The incoming nuclides may also include ion clusters, e.g., D₃⁺ (a positively charged ions group including three D nuclei), and the like.

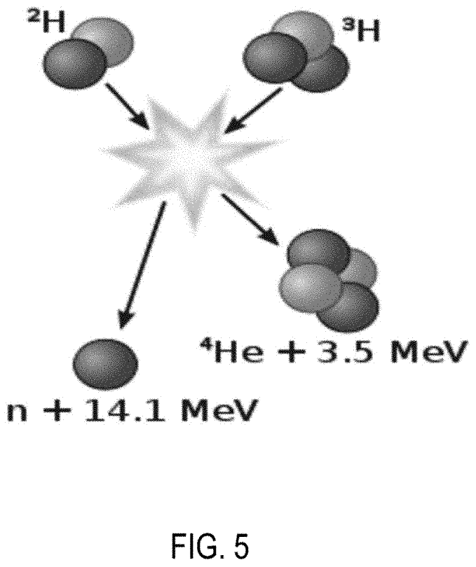

FIG. 5 is a schematic diagram illustrating fusion caused by collision of D and T. As shown, the fusion between ²H (D) and ³H (T) produces a high energy neutron (n, with an energy of about 14.1 MeV) and a high energy helium nuclide ⁴He with an energy of about 3.5 MeV. That is, D/T of fusion can contribute about 17.6 MeV energy. Relative to the incident energy 10˜100 keV, the amplification factor of the energy of the reaction is about 170 to 1,700. Energetic particles produced by nuclear fusion can be collected for use, for example, in energy generation.

In addition, collisions between D and D or T and T can also cause nuclear fusion. In these cases, the energy required will be higher than that in the D/T collision. Fusion between T/T will require still higher collision energy, and the probability of occurrence would be correspondingly lower. Thus, in some embodiments of the present disclosure, the main consideration is focused on D/T collision. It should be understood that the invention does not exclude the possibility of D and D, or T and T collision and fusion. That is to say, the second incident (second) isotopes can be the same or different from the first isotopes.

As described above, since there is the presence of lattice channels, the nuclides (e.g., ions of D/T) that enter into the channels of the crystal lattice (e.g., D/T of the ions) suffer from much less Bremsstrahlung radiation or deceleration radiation. They can collide with nuclides located more deeply in the target, and have a larger collisional cross-section with interstitial nuclides.

The rate of nuclear fusion reaction f is defined as f=n₁n₂<σν>, wherein n₁ and n₂ are the concentrations (density) of the incident beam and the reactant of the target within (i.e., isotopes of hydrogen), respectively, σ is the reaction cross section, and ν is velocity (relative velocity of the incident nuclide to lattice). Thus, the reaction rate in the lattice channels will be greatly improved, at least because the density is higher for both incident and resident nuclides.

In some exemplary embodiments of a thin target, for example, the thickness may be 5 μm or less. Incident nuclides of D/T having an energy of 10 keV or higher may reach a depth of about 0.5 μm into the target. The number of collisions of deuterium/tritium is proportional to the density or concentration of the deuterium/tritium in the incident beam and in the target, as well as the projection range of radionuclides. Concentration of incident D/T particles can vary in different embodiments. In certain embodiments, the concentration of incident D/T particles may be, for example, but is not limited to, 1×10¹² atom/cm² to 1×10¹⁸ atom/cm². According to some embodiments of the present invention, each incident ion on average can have chances for 250 collisions. In embodiments of the invention, it is calculated that, if every 100 incident D/T nuclides produce a nuclear fusion reaction, energy balance can be achieved. Alternatively, if every 34,000 deuterium/tritium collisions can produce one single thermonuclear reaction, energy balance can be achieved.

Further, the target thickness described above allows high-energy nuclides resulting from the fusion (particles, e.g., n neutrons and helium ⁴He) to quickly escape from the target and be collected by energy collecting apparatus or detectors. The selected thickness also makes it possible to easily control the temperature of the target, which, on the one hand makes it easy to maintain its lattice structure, e.g., to reduce the lattice vibrations, and, on the other hand, it is also easy to control recrystallization to maintain the single crystalline structure.

In some embodiments, the residual unreacted incident D/T nuclides in the target can be diffused in the target and settle as interstitial nuclides, which can be collided with the subsequent incident nuclides, that is, as subsequent reaction “fuel.” Further, the composition of the incident beam can be adjusted according to the content of the D/T in the target, e.g., by adjusting the amount of T/D, or switching between the T/D. Since the monocrystalline state of the target is maintained, the target that is depleted of the “fuel” can be easily reused, thereby saving resources.

In some embodiments, preferably, the incident surface 407 of the target, as shown in FIG. 4, is substantially perpendicular to the channels in the single crystalline lattice of the metal element. For example, in FIG. 4, the incident surface 407 of the Pd target is substantially along the [100] crystal planes of single crystalline lattice

In addition, as described above, lattice vibration can be constrained by low temperature, reducing its effect on the incident beam, such as through scattering. Even though the high energy incident beam and fusion reaction may damage the lattice, the high-temperature and the incident beam may promote recrystallization of the damaged lattice. In this regard, the lowering of the temperature may promote rapid recrystallization. Those skilled in the art will appreciate that adjustments can be made based on the radiation intensity, the duration of time, and the recrystallization temperature.

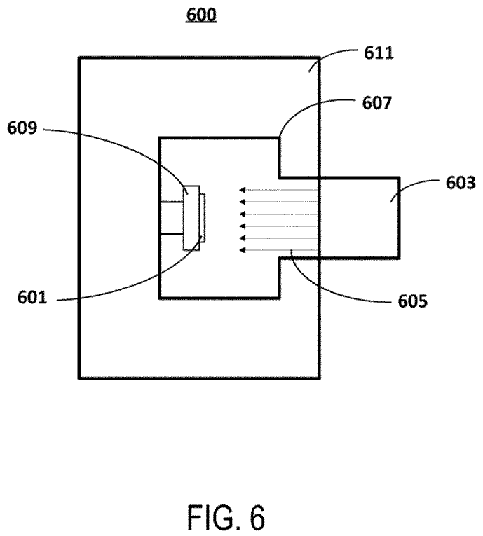

FIG. 6 is a simplified schematic diagram illustrating a system 600 for nuclides bombarding nuclides according to an embodiment of the invention. System 600 includes a single-crystalline target 601 including first hydrogen isotopes, and a bombardment apparatus 603 configured for injecting second isotopes of hydrogen (605) into the target substantially along the lattice channels of the single crystal lattice. In some embodiments, the second isotopes of hydrogen are injected into the target using an energy of 10 KeV or higher. In some embodiments, the bombardment apparatus can include an ion implantation equipment for semiconductor processing that is configured to inject the second isotopes of hydrogen.

As shown in FIG. 6, system 600 may also include a target support 609 in a chamber 607. In some embodiments, a cooling apparatus may be provided in the support 609 for lowering the target temperature to reduce the vibration of the single crystal lattice and/or to promote recrystallization. In addition, monitoring or sensing devices can be installed in the chamber 607 and, in particular, support 609, in order to monitor and control the reaction and system operation. For example, such sensing devices can be configured to monitor the temperature of the target and the target of the D/T content, and so on, as previously described, so to adjust the composition of the beam, the incident power, and injection duration (duty cycle) etc.

Further, the system 600 may also include an energy collection device 611 for collecting the high-energy particles and energies produced by the collisions of the first hydrogen isotopes by the second hydrogen isotopes. For example, the energy collection device can include water storage containers, which may be an external system, e.g. a part of a system using steam generation. In various embodiments, the harvested energy can be used to generate electricity.

In embodiments of the invention, the energy amplification factor can be expressed as follows:

\tilde{M}_{E}=Y·M_{E}·M_{V}·M_{A}·M₁·M_{con}=10⁻⁵·10³·38·38·3·1≈43

in which:
Y represents the probability of fusion reaction between incident particles (D/T) and impurity particles or interstitial particles (T/D), in a random direction injection, or injection not along the direction of the lattice channels. Often, Y is in the order of 10⁻⁵ to 10⁻⁶; here, 10⁻⁵ is taken in the ideal case.

M_{E} represents the energy magnification factor of the fusion caused by collision of incident particles and impurity particles (D-D or D-T). The factor can be in the range of 100 to 1,700 with an injection energy of 10 KeV to 100KeV. Here, the factor is taken to be 1,000.

M_{V} represents the geometric magnification factor on the incident particles caused by the “squeeze” or “funnel” effect by injection into the lattice channel. As describe above, the factor is taken to be 38.

M_{A}, similar to M_{V}, represents the geometric magnification factor on the impurity or interstitial particles caused by the “squeeze” or “funnel” effect by injection into the lattice channel.

M₁ represents a magnification factor in the target penetration depth caused by injection along the lattice channel direction versus random direction injection. It is approximately 3.

M_{con} represents a ratio between the concentration absorbed by isotopes and the concentration in a conventional target. It is taken to be 1.

Under a conservative estimation, the energy amplification factor can be expressed as follows:

\tilde{M}_{E}=Y·M_{E}·M_{V}·M_{A}·M₁·M_{con}=10⁻⁶·170·38·38·2·3≈1.4.

In this calculation, Y is 10⁻⁶, M_{E} is 170, M_{V} is about 38, M_{A} is about 38, and M₁ is 2. It can be seen that even under a conservative estimate, a positive energy output can be expected. In other words, in embodiments of the invention, energy balance can be achieved. It is also possible to positive and higher energy output.

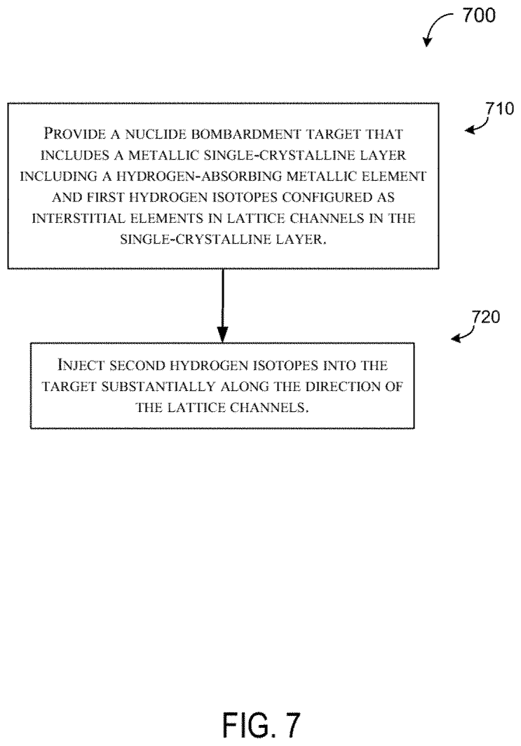

FIG. 7 is a simplified flowchart of a method for nuclide bombardment. As shown in FIG. 7, method 700 can be summarized briefly below.

Process 710: Provide a nuclide bombardment target that includes a metallic single-crystalline layer including a hydrogen-absorbing metallic element and first hydrogen isotopes configured as interstitial elements in lattice channels in the single-crystalline layer; and
Process 720: Inject second hydrogen isotopes into the target substantially along the direction of the lattice channels.

Various details of the method are described above with reference to FIGS. 1-6.

Enhanced Neutron Generation

In some embodiments, methods are provided for enhanced neutron generation for medical application or transmutation of fission waste products, with improved bombardment process and reaction process control.

In some embodiments of the present invention, a method is provided for nuclide bombardment for neutron generation. The method includes providing a nuclide bombardment target. The target includes a metallic single-crystalline layer including a hydrogen-absorbing metallic element, and the single-crystalline layer has lattice channels disposed of therein. The target also includes first hydrogen isotopes, configured as interstitial elements in the lattice channels in the single-crystalline layer. The method also includes positioning the metallic single-crystalline layer with respect to a bombardment apparatus, such that the bombardment apparatus is configured for injecting particles into the metallic single-crystalline layer substantially along the lattice channels of the single crystalline lattice. Next, second hydrogen isotopes are injected into the target substantially along the direction of the lattice channels, to allow deeper penetration, thereby increasing neutron generation.

Some embodiments of the above method also includes positioning the metallic single-crystalline layer to receive the second hydrogen isotopes at a selected incident angle for increased neutron generation. The selected incident angle can be determined by varying the incident angle of the second hydrogen isotopes with respect to the metallic single-crystalline layer. For example, the target of the metallic single-crystalline layer can be rotated with respect to the incident beam during the bombardment, and the backscattered particle counts can be measured and compared. In other embodiments, once an optimal incident angle is determined, it can be used with identical or similar targets.

In some embodiments, wherein injecting isotopes of the second element into the target comprises injecting isotopes of the second element with energy in the range of 10 to 500 keV, and causing nuclear reaction between the first isotope and the second isotope. In some embodiments, the metallic element can be selected from Pt, Pd, Ti, or Ni. The first hydrogen isotope can be deuterium (D) or tritium (T), and the second hydrogen isotope is deuterium (D) or tritium (T). In some cases, the first hydrogen isotope is deuterium (D), and the second isotope is deuterium (D). In other cases, the second hydrogen isotope can be different from the first isotope. For example, in some embodiments, the first hydrogen isotope is deuterium (D) and the second isotope is tritium (T). In other embodiments, the first hydrogen isotope is tritium (T) and the second isotope is deuterium (D).

The inventor has performed experiments to demonstrate the method enhanced neutron production using channeling-based bombardment described above. First, single-crystal PdDx with x=0.65 was formed by exposing single crystal Pd to pure D in high pressure and temperature. Next, the DD reaction experiments were performed in an RBS (Rutherford Backscattering Spectrometry) chamber. RBS spectrometry was also used for material characterization.

Rutherford backscattering spectrometry (RBS) is an analytical technique often used in materials science. RBS is used to determine the structure and composition of materials by measuring the backscattering of a beam of high energy ions (typically protons or alpha particles) impinging on a sample. An RBS instrument generally includes three components: an ion source, a linear particle accelerator, and a detector. The ion source can include alpha particles (He2+ ions) or protons, etc. The linear particle accelerator is capable of accelerating incident ions to high energies, usually in the range 1-3 MeV. The detector is capable of measuring the energies of backscattered ions over some range of angles.

Two common source/acceleration arrangements can be used in commercial RBS systems, working in either one or two stages. One-stage systems consist of a He+ source connected to an acceleration tube with a high positive potential applied to the ion source, and the ground at the end of the acceleration tube. This arrangement is simple and convenient, but it can be difficult to achieve energies of much more than 1 MeV due to the difficulty of applying very high voltages to the system. Detectors to measure backscattered energy can include silicon surface barrier detectors, a very thin layer (100 nm) of P-type silicon on an N-type substrate forming a p-n junction. Ions which reach the detector lose some of their energy to inelastic scattering from the electrons, and some of these electrons gain enough energy to overcome the band gap between the semiconductor valence and conduction bands. This means that each ion incident on the detector will produce some number of electron-hole pairs which is dependent on the energy of the ion. These pairs can be detected by applying a voltage across the detector and measuring the current, providing an effective measurement of the ion energy. The relationship between ion energy and the number of electron-hole pairs produced will be dependent on the detector materials, the type of ion and the efficiency of the current measurement; energy resolution is dependent on thermal fluctuations. Angular dependence of detection can be achieved by using a movable detector, or more practically by separating the surface barrier detector into many independent cells which can be measured independently, covering some range of angles around direct (180 degrees) back-scattering. Angular dependence of the incident beam is controlled by using a tiltable sample stage.

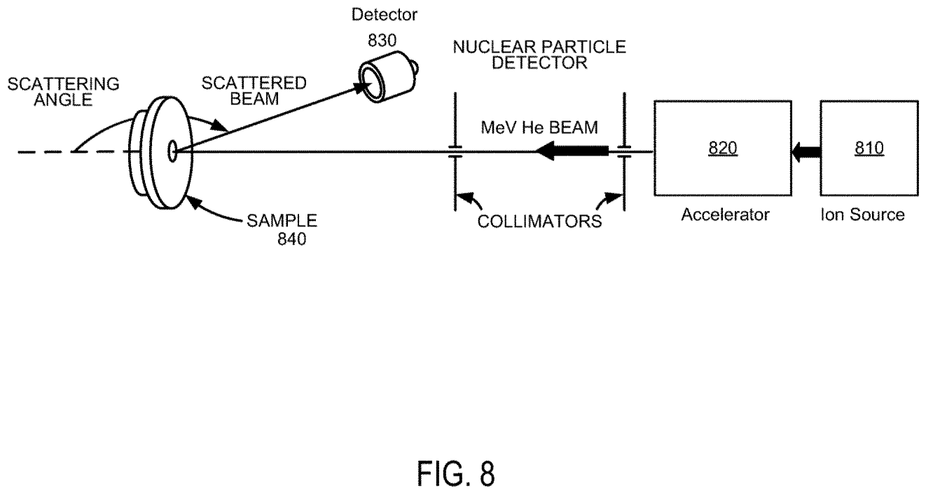

FIG. 8 is a simplified diagram of an RBS (Rutherford Backscattering Spectrometry) system according to the embodiments of the present invention. RBS system 800 includes an ion source 810, a linear particle accelerator 820, and a detector 830. FIG. 8 also shows a sample of 840. In the experiments described below, sample 840 can include a target of a metallic single-crystalline layer. The DD reaction experiments were performed using the RBS system with the incident beam of hydrogen isotopes. For material analysis, MeV He beams were used.

Experimental Results

Beam target nuclear fusion reaction is enhanced by using a single crystal target and aligning the incident ion beam to channeling direction. D ions bombard a single crystal Palladium (Pd) Deuteride (D) target, PdDx, in random or channel mode. Ion channeling in a single crystal reduces Bremsstrahlung's loss and enhances penetration. D atoms in PdDx are known to be in octahedral sites of the Pd FCC lattice, along the axial channel. Upon entering the crystal under channeling, uniformly distributed D ions become focused and stay within the channel where the interstitial D atoms are located. The focusing of incident ions, termed flux peaking, will change the spatial distribution of the beam with greater intensity at channel center and a reduced intensity at channel boundaries. Penetration depth increase and flux peaking contribute to the enhancement of DD reaction.

First, single-crystal PdDx with x=0.65 was formed by exposing single crystal Pd to pure D in high pressure and temperature. Next, the DD reaction experiments were performed in an RBS (Rutherford Backscattering) chamber. The experiments are described in more detail below.

Palladium hydride is a metallic palladium that contains a substantial quantity of hydrogen within its crystal lattice. At room temperature and atmospheric pressure, palladium can absorb up to 900 times its own volume of hydrogen. This process is reversible. The absorption of hydrogen produces two different phases, both of which contain palladium metal atoms in a face-centered cubic (fcc) lattice, which is the same structure as pure palladium metal. At low concentrations up to PdH_{0.02}, the palladium lattice expands slightly, from 3.889 Å (angstroms) to 3.895 Å. Above this concentration, the second phase appears with a lattice constant of 4.025 Å. Both phases coexist until a composition of PdH_{0.58} when the alpha phase disappears. Neutron diffraction studies have shown that hydrogen atoms randomly occupy the octahedral interstices in the metal lattice (in an fcc lattice there is one octahedral hole per metal atom). The limit of absorption at normal pressures is PdH_{0.7}, indicating that approximately 70% of the octahedral holes are occupied. The absorption of hydrogen is reversible, and hydrogen rapidly diffuses through the metal lattice. Metallic conductivity reduces as hydrogen is absorbed until at around PdH_{0.5} the solid becomes a semiconductor. Further details can be found in “The H—Pd (Hydrogen-Palladium) System,” F. D. Manchester, et. al., Journal of Phase Equilibria Vol. 15 No. 1, pg. 62, 1994, incorporated herein by reference.

In some embodiments, single crystal Pd is exposed to D2 gas at high temperature and pressure for sufficient time to ensure a uniform D distribution throughout the material. To ensure maintenance of single-crystal, the PdDx formation process can use a temperature from about 300° C. to about 500° C., and pressure of 2 MPa to 10 MPa. Two phases of PdDx, with a different lattice constant, coexist under the parabolic curve, causing stress and polycrystalline formation.

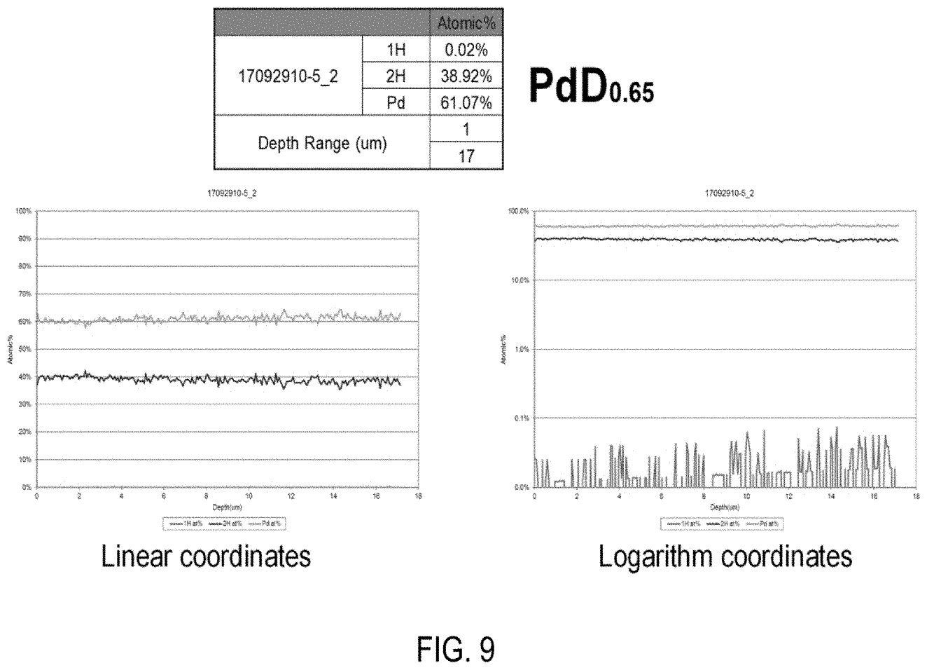

SIMS (Secondary Ion Mass Spectrometry) was used to measure a PDD_{0.65} sample. FIG. 9 shows a summary of results from SIMS measurements in both linear coordinates and logarithm coordinates according to the embodiments of the present invention. The D distribution is relatively constant from the service into the bulk. This is consistent with the calculation based on the diffusion constant and reaction time. Without H contamination, the change in weight as measured by a high precision scale can be attributed to D and the x in PdDx can be precisely determined.

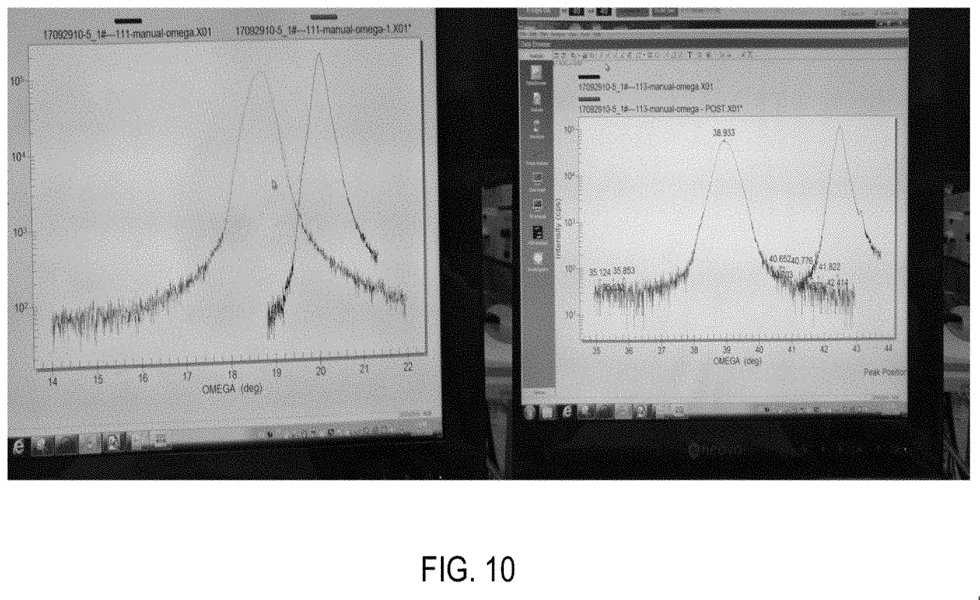

Further, XRD (X-Ray Diffraction) was used to characterize the sample. Diffraction peaks before and after single crystal PdDx formation. FIG. 10 shows results from XRD (X-ray diffraction) measurements according to embodiments of the present invention. FIG. 10 shows diffraction peaks before and after single crystal PdDx formation in two separate screen images. Each screen image shows two peaks. The peaks on the right are Pd after removal of the surface damage layer.

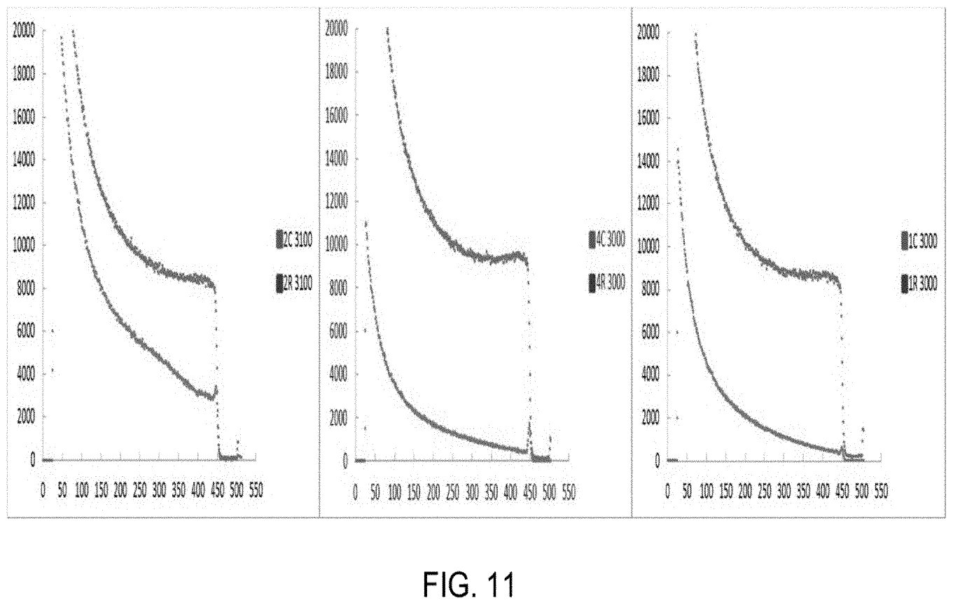

FIG. 11 shows results from random and channeling RBS measurements according to embodiments of the present invention. Random and Channeling RBS Measurements were carried out. From left to right, as received single crystal Pd sample, with surface damage layer removed, and after the formation of PdDx. Khi value, a crystal quality indicator, of 4.5% is obtained for the PdDx, where x=0.65. It shows that the sample is a good quality single crystal. A few atomic layer of disorder is left after the initial damage layer removal, as indicated by the surface peak. The thermal treatment during PdDx formation minimized the surface disorder layer as indicated by the reduction of the surface peak.

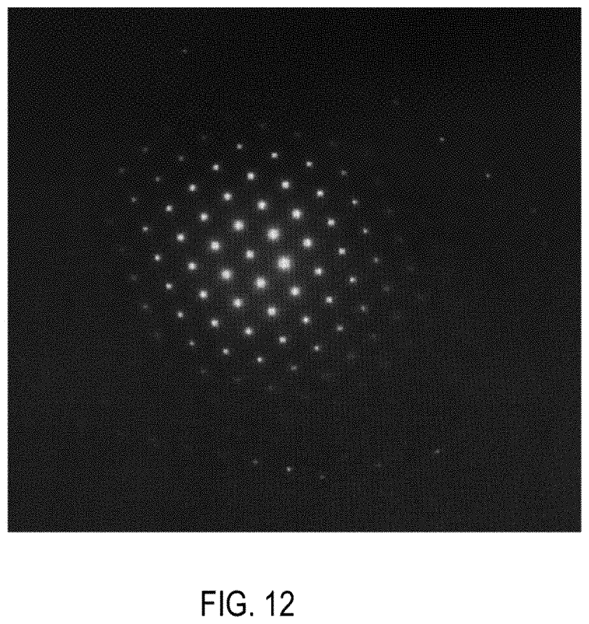

FIG. 12 shows results from TEM (Transmission Electron Microscope) measurements according to embodiments of the present invention. Rings of diffraction pattern, which indicates a polycrystalline material, was not observed. Instead, a clear and well-defined TEM diffraction pattern, confirming the presence of single crystal structure, was observed. Under high magnification, the presence of dislocation and stacking faults can be identified.

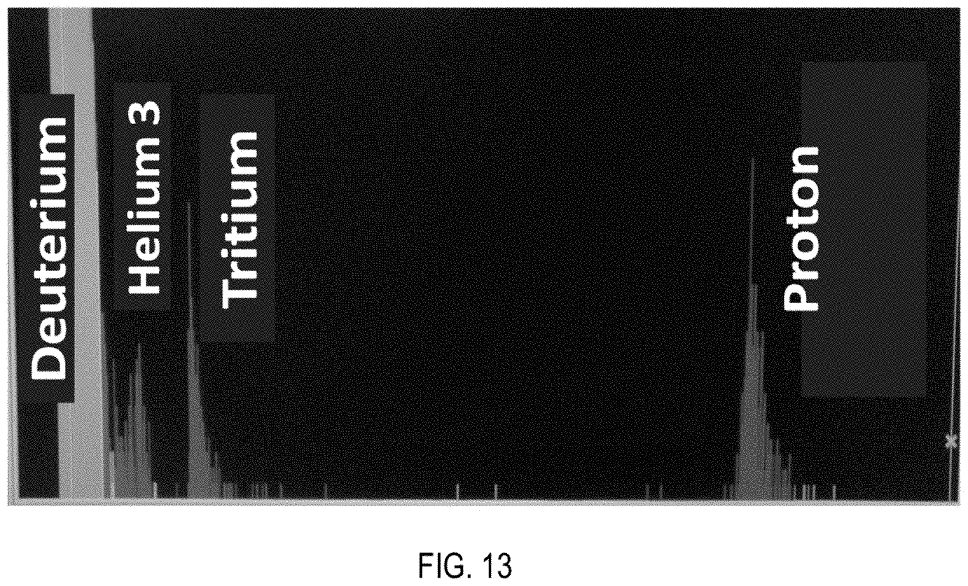

Experiments of the D2+ ion beam bombarding a PdDx target were carried out in an RBS system, and the backscattered ions were measured using the detector in the RBS system. FIG. 13 shows the output energy spectrum during D2+ ion beam bombarding the PdDx target according to the embodiments of the present invention. The results shown in FIG. 13 were from a 300 Key D2+ ion beam bombarding a PdDx target. As described above, the DD (Deuterium-Deuterium) reaction products can be described by the following equation.

½D+½D→⅓T+p→⅔He+n

The output energy spectrum with a 300 KeV D2+ ion beam bombarding the PdDx target is shown in FIG. 13. Three product peaks are shown: proton, tritium, and helium3, respectively. The backscattered Deuterium is also present. This result illustrates that the fusion reaction described by the above equation occurred.

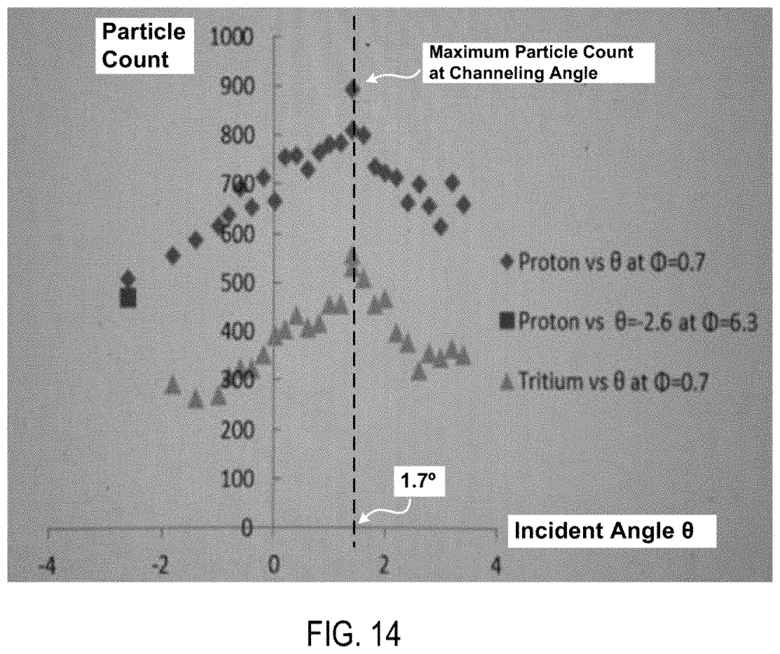

The experiments also include rotating the PdDx target with respect to the incident D2+ ion to determine the effect of channeling on neutron production. FIG. 14 illustrates the experimental results of particle counts in channeling-enhanced fusion reaction according to embodiments of the present invention. In FIG. 14, the integrated proton and tritium counts are plotted as a function of incident angle θ under 300 KeV D₂⁺ ion beam bombardment. The horizontal axis shows the incident angle θ, and the vertical axis shows particle counts. It can be seen that channeling occurred at around an incident angle θ=1.7 degrees, where the maximum particle counts are detected. As the target is rotated away from the channel incident angle of θ=1.7 degrees, the particle counts decreases. The enhancement of fusion reaction, between 1.6× to 2×, is observed under channeling conditions, as indicated by the increased reaction product particle counts.

As described above, experiments to use a single crystal target to enhanced DT reaction in a beam-target setup have been made. The process of incorporating high concentration D into single crystal Pd target, encasing the D atoms into octahedral sites of the Pd lattice, has been investigated. Single crystal PdDx was characterized using SIMS, XRD, RBS and, TEM. SIMS data indicates that D distribution is uniform and there is no Hydrogen contamination. The sharp peaks of the XRD again indicate that the PdDx is a good single crystal. The shifting of the XRD peaks is consistent with the lattice constant difference between Pd and PdDx. Both RBS and TEM show that the PdDx so fabricated are of good single crystal quality.

Using a high precision scale, the amount of D in PdDx can be measured. Single crystal PdDx with x between 0.45 to 0.65 has been made. It is the highest D containing single crystal PdDx reported in the literature so far. By bombarding the PdDx target with 300 KeV D2⁺ beam, DD fusion reaction products, including proton, tritium, and helium3 can be clearly identified. The amount of fusion reaction can be enhanced by a factor between 1.6× to 2× under channeling conditions in the experiments described above. The method of efficiency of neutron generation is viable for applications such as medical applications, or transmutation of fission waste products, etc. In embodiments of the invention, the efficiency of neutron generation apparatus based on nuclides bombardment can be substantially improved using the methods described above for single-crystalline target preparation and channeling-based bombardment.

Even though experimental results described above were based on Palladium hydride taargets, other hydride systems are also contemplated in embodiments of the invention, such as binary hydrogen compound systems (e.g., TiH₂, ErH₂), or hydrogen solutions with high hydrogen solubility, (e.g., LaH≥2.03, CeH≥2.5, UH≥3.00).

It is also understood that, although the embodiments are described above in the context of hydrogen and its isotopes, the present invention is not limited to this. Those skilled in the art in accordance with the teachings of the present disclosure will understand that the principles of the present invention may also be applied to other fusion fuels, e.g., helium isotope (e.g., ³He), boron isotopes (e.g., ¹¹B), and the like. Similarly, the other fusion fuels can be used with a corresponding target material that has appropriate fuel absorbing properties.

Other embodiments are also contemplated that include an additional target for bombardment nuclides and nuclides bombarding systems. The target may include a thin layer of a single crystal of a target body or isotopes of a first element forming interstitial nuclides disposed of in the lattice channels in the single-crystal thin layer. In some embodiments, the isotopes of the first element form a matrix of nuclides substantially along the lattice channels of the single crystal lattice. The first element can be incorporated in the target body using various methods, such as adsorption-diffusion, doping-diffusion, solid solution, or an injection-annealing process and so on. Crystallization processes (for example, annealing) can be used to maintain the target in the single-crystalline state

The system may also include nuclide bombardment means for injecting the isotopes of a second element into the target substantially along the lattice channels of the single crystal lattice. It should be understood, the first element and the second element may be the same or different elements, and isotopes of the first element and the second element isotopes may be the same or different. It should also be appreciated that, in some implementations, preferably the first element isotopes and isotopic said the second element is selected for fusion reaction through collision reaction. For example, the first and second elements may be selected from the periodic table from hydrogen to iron, and their isotopes. For example, the first element may be selected from isotopes of hydrogen, isotopes of helium, isotopes of boron, and isotopes of aluminum. Those skilled in the art can readily select the second element for the fusion reaction with the first element, and the corresponding target material, in accordance with the above description.

Although certain embodiments of the present invention are described in detail, those skilled in the art will appreciate that the above examples are for illustration only and not to limit the scope of the invention. Thus, those skilled in the art would appreciate that, aside from embodiments of the present disclosure, various modifications and changes can be made without departing from the spirit and scope of the present disclosure.

What is claimed is:

1. A method for nuclide bombardment for neutron generation, comprising:
providing a nuclide bombardment target, the target including:
a metallic single-crystalline layer including a hydrogen-absorbing metallic element, the single-crystalline layer including lattice channels disposed of therein; and
first hydrogen isotopes, configured as interstitial elements in the lattice channels in the single-crystalline layer;
positioning the metallic single-crystalline layer with respect to a bombardment apparatus, such that the bombardment apparatus is configured for injecting particles into the metallic single-crystalline layer substantially along the lattice channels of the single crystalline lattice; and
injecting second hydrogen isotopes into the target substantially along the direction of the lattice channels, thereby increasing neutron generation.

2. The method of claim 1, further comprising positioning the metallic single-crystalline layer to receive the second hydrogen isotopes at a selected incident angle for increased neutron generation, the selected incident angle being determined by varying the incident angle of the second hydrogen isotopes with respect to the metallic single-crystalline layer.

3. The method of claim 1, wherein injecting the second hydrogen isotopes into the target comprises injecting second hydrogen isotopes with an energy in the range of 10 to 200 keV.

4. The method of claim 1, wherein injecting isotopes of the second element into the target comprises injecting isotopes of the second element with energy in the range of 10 to 500 keV.

5. The method of claim 1, wherein the single-crystalline layer is characterized by a thickness of 5 um or less.

6. The method of claim 1, wherein a surface of the target is substantially perpendicular to the lattice channels in the single-crystalline lattice.

7. The method of claim 1, wherein the metallic element is selected from Pt, Pd, Ti, or Ni.

8. The method of claim 1, further comprising causing nuclear reaction between the first isotope and the second isotope.

9. The method of claim 1, wherein the first hydrogen isotope is deuterium (D) or tritium (T).

10. The method of claim 1, wherein the second hydrogen isotope is deuterium (D) or tritium (T).

11. The method of claim 1, wherein the first hydrogen isotope is deuterium (D) and the second isotope is deuterium (D).

12. The method of claim 1, wherein the second hydrogen isotope is different from the first isotope.

13. The method of claim 1, wherein the first hydrogen isotope is deuterium (D) and the second isotope is tritium (T).

14. The method of claim 1, wherein the first hydrogen isotope is tritium (T) and the second isotope is deuterium (D).

15. A method for nuclide bombardment for neutron generation, comprising:
providing a nuclide bombardment target, the target including:
a metallic single-crystalline layer including a metallic element, the single-crystalline layer including lattice channels disposed of therein; and
isotopes of a first element, configured as interstitial elements in the lattice channels in the single-crystalline layer;
positioning the metallic single-crystalline layer with respect to a bombardment apparatus, such that the bombardment apparatus is configured for injecting particles into the metallic single-crystalline layer substantially along the lattice channels of the single crystalline lattice; and
injecting isotopes of a second element into the metallic single-crystalline layer substantially along the direction of the lattice channels, thereby increasing neutron generation.

16. The method of claim 1, further comprising positioning the metallic single-crystalline layer to receive the isotopes of a second element at a selected incident angle for increased neutron generation, the selected incident angle being determined by varying the incident angle of the second hydrogen isotopes with respect to the metallic single-crystalline layer.

17. The method of claim 15, further comprising causing nuclear reaction between the isotopes of the first element and the isotopes of the second element.

18. The method of claim 15, wherein the first element comprises one or more of hydrogen, helium, boron, and aluminum, and the second element comprises one or more of hydrogen, helium, boron, and aluminum.

19. The method of claim 15, wherein the first element is different from the second element.

20. The method of claim 15, wherein the metallic element is selected from Pt, Pd, Ti, or Ni.
